(19) United States
(12) Patent Application Publication
(10) Pub. No.: US 2023/0124446 A1
(43) Pub. Date: Apr. 20, 2023

(54) Back Massaging Assembly

(71) Applicant: Patrick Brian, Georgetown, TX (US)

(72) Inventor: Patrick Brian, Georgetown, TX (US)

(21) Appl. No.: 17/505,051

(22) Filed: Oct. 19, 2021

(51) Int. Cl. A61H 15/00

(52) U.S. Cl. CPC A61H 15/0078; A61H 2201/0142; A61H 2205/081; A61H 2015/0057; A61H 2015/0014

(57) ABSTRACT

A back massaging assembly for realigning vertebrae of a user includes a pad, which is positioned on an upper face of a bench. A roller module is positioned in a void that is positioned in the pad. The roller module comprises a rotatable cylinder, which extends substantially between opposed edges of the void. An upper limit of the rotatable cylinder extends past an upper surface of the pad. An actuator is operationally engaged to the roller module and is positioned to cycle the rotatable cylinder between a first edge and a second edge of the void, thereby massaging a back of a user who is lying supinely on the pad.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to massaging assemblies and more particularly pertains to a new massaging assembly for realigning vertebrae of a user. The present invention discloses a massaging assembly comprising a bench and a pad which can be covered with a cover. A roller module comprising a rotatable cylinder is positioned in a void in the pad. The rotatable cylinder is configured to roll along a back of a user lying on the bench to realign vertebrae of the user. The massaging assembly of the present invention is highly compact and thus readily transportable by the user.

### (2) Description of Related Art Including Information Disclosed Under 37 CFR 1.97 and 1.98

The prior art relates to massaging assemblies, which may comprise assemblies comprising rotating discs the traverse spinal columns of users, assemblies comprising pluralities of nubbed wheels that roll along back of users, and assemblies comprising pluralities of rollers, wherein each roller engages a respective portion of a back of a user. What is lacking in the prior art is a massaging assembly comprising a bench and a pad which can be covered with a cover. A roller module comprising a rotatable cylinder is positioned in a void in the pad. The rotatable cylinder is configured to roll along a back of a user lying on the bench to realign vertebrae of the user

### BRIEF SUMMARY OF THE INVENTION

An embodiment of the disclosure meets the needs presented above by generally comprising a pad, which is positioned on an upper face of a bench. A roller module is positioned in a void that is positioned in the pad. The roller module comprises a rotatable cylinder, which extends substantially between opposed edges of the void. An upper limit of the rotatable cylinder extends past an upper surface of the pad. An actuator is operationally engaged to the roller module and is positioned to cycle the rotatable cylinder between a first edge and a second edge of the void. The rotatable cylinder thus is configured to massage a back of a user who is lying supinely on the pad. The massaging assembly of the present invention is highly compact and thus readily transportable by the user.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a back massaging assembly according to an embodiment of the disclosure.

FIG. 2 is an exploded view of an embodiment of the disclosure.

FIG. 3 is a top view of an embodiment of the disclosure.

FIG. 4 is a rear view of an embodiment of the disclosure.

FIG. 5 is a bottom view of an embodiment of the disclosure.

### DETAILED DESCRIPTION OF THE INVENTION

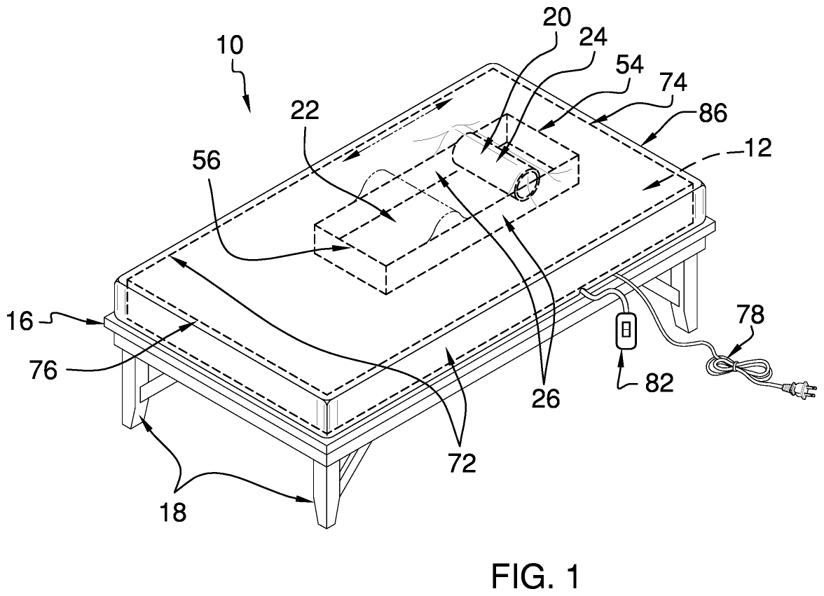

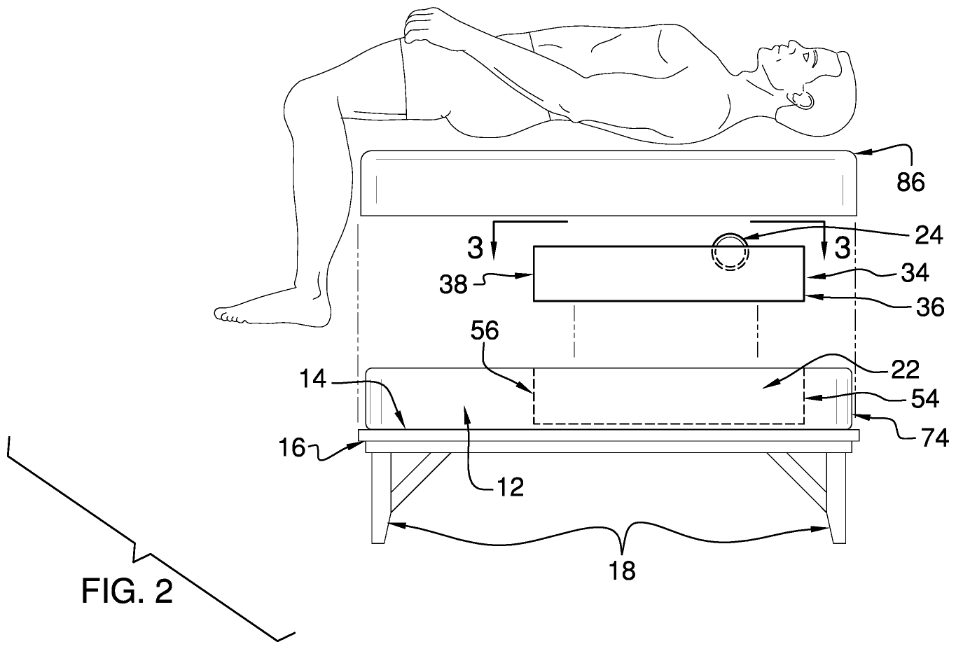

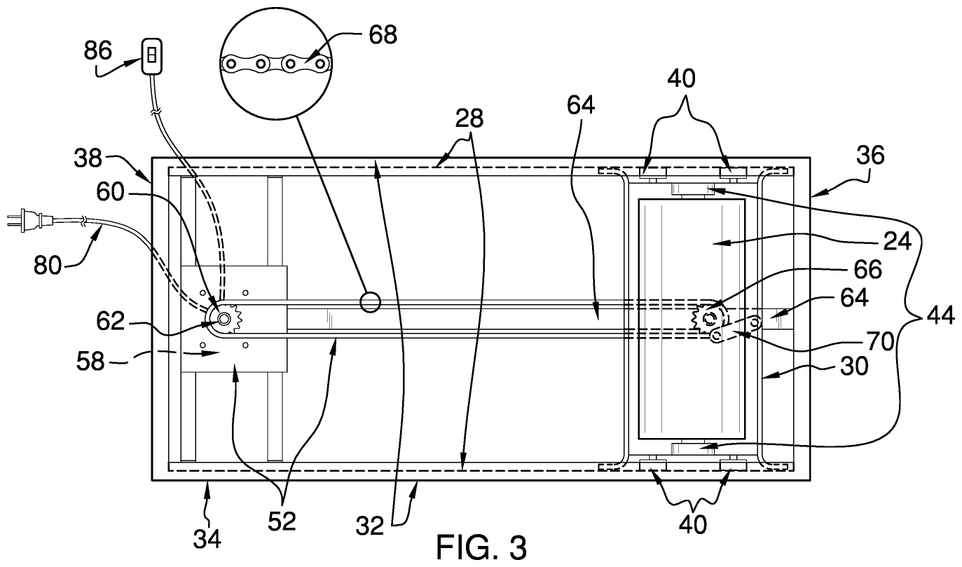

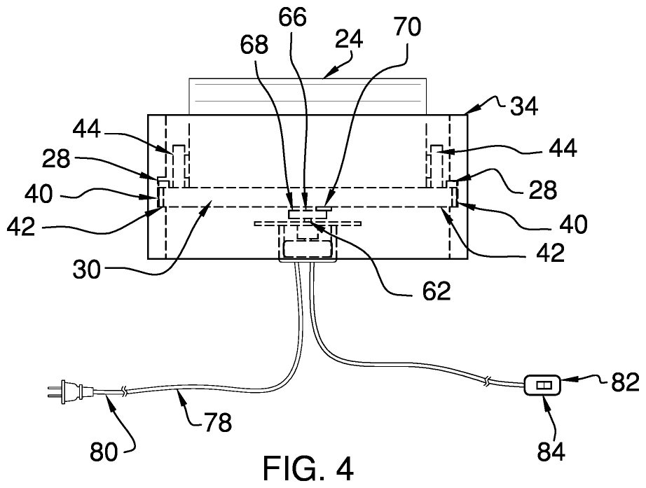

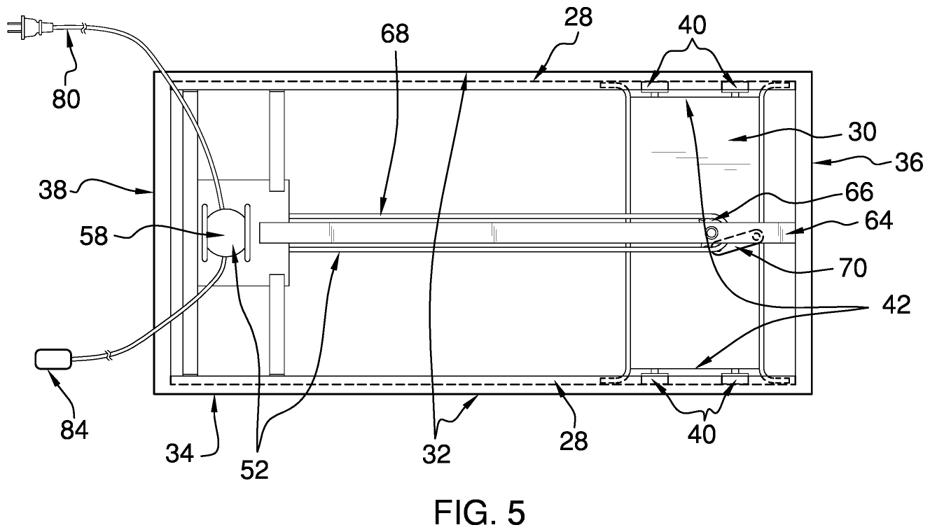

With reference now to the drawings, and in particular to FIGS. 1 through 5 thereof, a new massaging assembly embodying the principles and concepts of an embodiment of the disclosure and generally designated by the reference numeral 10 will be described.

As best illustrated in FIGS. 1 through 5, the back massaging assembly 10 generally comprises a pad 12, which is positioned on an upper face 14 of a bench 16. The present invention anticipates legs 18 of the bench 16 being one or both of foldable and selectively extensible to facilitate transport of the back massaging assembly 10. The present invention also anticipates a lower leg support (not shown), which is selectively extensible from or hingedly engaged to the bench 16.

A roller module 20 is positioned in a void 22 that is positioned in the pad 12. The roller module 20 comprises a rotatable cylinder 24, which extends substantially between opposed edges 26 of the void 22. The roller module 20 may comprise a pair of rails 28 and a plate 30. The rails 28 are engaged singly to opposed sides 32 of a rectangular frame 34 and extend from proximate to a first endpoint 36 to proximate to a second endpoint 38 of the rectangular frame 34. Each of a plurality of wheels 40 is rotationally engaged to a respective opposed end 42 of the plate 30 and is operationally engaged to a respective rail 28. Each of a pair of arms 44 is engaged to and extends from the plate 30 proximate to a respective opposed end 42 of the plate 30. The rotatable cylinder 24 is rotationally engaged to and extends between the arms 44. The rotatable cylinder 24 may have a length 46 of between 8.0 and 16.0 centimeters. The rotatable cylinder 24 may have a length 46 of between 10.0 and 14.0 centimeters.

An upper limit 48 of the rotatable cylinder 24 extends past an upper surface 50 of the pad 12. The upper limit 48 of the rotatable cylinder 24 may extend from 3.0 to 7.0 centimeters above the upper surface 50 of the pad 12. The upper limit 48 of the rotatable cylinder 24 may extend from 4.5 to 5.5 centimeters above the upper surface 50 of the pad 12. The present invention also anticipates the rotatable cylinder 24 being selectively adjustable to allow the user to select a position of the upper limit 48 of the rotatable cylinder 24 relative to the upper surface 50 of the pad 12.

An actuator 52 is operationally engaged to the roller module 20 and is positioned to cycle the rotatable cylinder 24 between a first edge 54 and a second edge 56 of the void 22. The rotatable cylinder 24 thus is configured to massage a back of a user who is lying supinely on the pad 12.

The actuator 52 may comprise a motor 58, which engaged to the rectangular frame 34 proximate to the second endpoint 38 of the rectangular frame 34. A drive gear 60 engaged to a shaft 62 of the motor 58. A rod 64 is engaged to and extends from the first endpoint 36 of the rectangular frame 34. A cog wheel 66 is rotationally engaged to the rod 64 distal from the first endpoint 36. An endless chain 68 is gearedly engaged to the drive gear 60 and the cog wheel 66. A bar 70 is rotationally engaged to and extends between the endless chain 68 and the plate 30. As the endless chain 68 rotates around the drive gear 60 and the cog wheel 66, the rotatable cylinder 24 is cycled the between the first edge 54 and the second edge 56 of the void 22. The present invention anticipates the actuator 52 comprising other actuating means, such as, but not limited to, worm gears, rack and pinions, and the like.

The void 22 is positioned equally distant from opposing sides 72 of the pad 12. The void 22 extends from proximate to a first end 74 toward a second end 76 of the pad 12 so that the rotatable cylinder 24 is positioned below vertebrae of the user. The rotatable cylinder 24 thus is configured to realign the vertebrae of the user. The void 22 is sized such that T1 and L5 vertebrae of the user are positioned above the rotatable cylinder 24.

The back massaging assembly 10 also comprises a power module 78, which is engaged to the rectangular frame 34 and which is operationally engaged to the motor 58 so that the power module 78 is positioned to selectively power the motor 58. The power module 78 may comprise a power cord 80, although the present invention also anticipates the motor 58 being battery powered.

A controller 82 is communicatively engaged to the power module 78 and the motor 58. The controller 82 is configured to be selectively manipulated by the user to selectively power the motor 58. The controller 82 may comprise an ON/OFF switch 84. The present invention also anticipates the controller 82 being wireless. The present invention further anticipates the controller 82 being configured to selectively control a rotational speed of the shaft 62, thus controlling a rate at which the rotatable cylinder 24 cycles between the first edge 54 and the second edge 56 of the void 22.

The back massaging assembly 10 also comprises a cover 86, which is shaped complementarily to the pad 12 so that the cover 86 is positionable over the pad 12, the void 22, and the rotatable cylinder 24. The cover 86 may be resiliently stretchable. The cover 86 may be padded.

In use, a user lies supinely on the pad 12 with the cylinder positioned across a spine of the user's back. The ON/OFF switch 84 is switched to engage the motor 58, causing the rotatable cylinder 24 to cycle between the first edge 54 and the second edge 56 of the void 22. Rotation of the rotatable cylinder 24 along the back of the user massages the back and realigns the vertebrae of the back. When the user wishes to relocate the back massaging assembly 10, this is readily accomplished due to its compactness and light weight.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A back massaging assembly comprising:
a bench;
a pad positioned on an upper face of the bench;
a void positioned in the pad;
a roller module positioned in the void, the roller module comprising a rotatable cylinder extending substantially between opposed edges of the void, an upper limit of the rotatable cylinder extending past an upper surface of the pad; and
an actuator operationally engaged to the roller module, such that the actuator is positioned for cycling the rotatable cylinder between a first edge and a second edge of the void, wherein the rotatable cylinder is configured for massaging a back of a user lying supinely on the pad.

2. The back massaging assembly of claim 1, wherein the void is positioned equally distant from opposing sides of the pad, the void extending from proximate to a first end toward a second end of the pad, such that the rotatable cylinder is positioned below vertebrae of the user, wherein the rotatable cylinder is configured for realigning the vertebrae of the user.

3. The back massaging assembly of claim 2, wherein the void is sized such that T1 and L5 vertebrae of the user are positioned above the rotatable cylinder.

4. The back massaging assembly of claim 1, wherein the rotatable cylinder has a length of between 8.0 and 16.0 centimeters.

5. The back massaging assembly of claim 4, wherein the rotatable cylinder has a length of between 10.0 and 14.0 centimeters.

6. The back massaging assembly of claim 1, wherein the upper limit of the rotatable cylinder extends from 3.0 to 7.0 centimeters above the upper surface of the pad.

7. The back massaging assembly of claim 6, wherein the upper limit of the rotatable cylinder extends from 4.5 to 5.5 centimeters above the upper surface of the pad.

8. The back massaging assembly of claim 1, wherein:
the roller module comprises:
a rectangular frame,
a pair of rails engaged singly to opposed sides of the rectangular frame and extending from proximate to a first endpoint to proximate to a second endpoint of the rectangular frame
a plate,
a plurality of wheels, each wheel being rotationally engaged to a respective opposed end of the plate and operationally engaged to a respective rail, and
a pair of arms, each arm being engaged to and extending from the plate proximate to a respective opposed end of the plate, the rotatable cylinder being rotationally engaged to and extending between the arms; and
the actuator comprises:
a motor engaged to the rectangular frame proximate to the second endpoint of the rectangular frame,
a drive gear engaged to a shaft of the motor,
a rod engaged to and extending from the first endpoint of the rectangular frame,
a cog wheel rotationally engaged to the rod distal from the first endpoint,
an endless chain gearedly engaged to the drive gear and the cog wheel, and
a bar rotationally engaged to and extending between the endless chain and the plate, such that, as the endless chain rotates around the drive gear and the cog wheel, the rotatable cylinder is cycled the between the first edge and the second edge of the void.

9. The back massaging assembly of claim 8, further including a power module engaged to the rectangular frame and being operationally engaged to the motor, such that the power module is positioned for selectively powering the motor.

10. The back massaging assembly of claim 9, wherein the power module comprises a power cord.

11. The back massaging assembly of claim 9, further including a controller communicatively engaged to the power module and the motor, wherein the controller is configured for being selectively manipulated by the user for selectively powering the motor.

12. The back massaging assembly of claim 11, the controller comprises an ON/OFF switch.

13. The back massaging assembly of claim 1, further including a cover shaped complementarily to the pad, such that the cover is positionable over the pad, the void, and the rotatable cylinder.

14. The back massaging assembly of claim 13, wherein the cover is resiliently stretchable.

15. The back massaging assembly of claim 13, wherein the cover is padded.

16. A back massaging assembly comprising:
a bench;
a pad positioned on an upper face of the bench;
a void positioned in the pad;
a roller module positioned in the void, the roller module comprising a rotatable cylinder extending substantially between opposed edges of the void, an upper limit of the rotatable cylinder extending past an upper surface of the pad, the void being positioned equally distant from opposing sides of the pad, the void extending from proximate to a first end toward a second end of the pad, such that the rotatable cylinder is positioned below vertebrae of a user lying supinely on the pad, the void being sized such that T1 and L5 vertebrae of the user are positioned above the rotatable cylinder, the rotatable cylinder having a length of between 8.0 and 16.0 centimeters, the rotatable cylinder having a length of between 10.0 and 14.0 centimeters, the upper limit of the rotatable cylinder extending from 3.0 to 7.0 centimeters above the upper surface of the pad, the upper limit of the rotatable cylinder extending from 4.5 to 5.5 centimeters above the upper surface of the pad, the roller module comprising:
a rectangular frame,
a pair of rails engaged singly to opposed sides of the rectangular frame and extending from proximate to a first endpoint to proximate to a second endpoint of the rectangular frame
a plate,
a plurality of wheels, each wheel being rotationally engaged to a respective opposed side of the plate and operationally engaged to a respective rail, and
a pair of arms, each arm being engaged to and extending from the plate proximate to a respective opposed end of the plate, the rotatable cylinder being rotationally engaged to and extending between the arms;
an actuator operationally engaged to the roller module, such that the actuator is positioned for cycling the rotatable cylinder between a first edge and a second edge of the void, wherein the rotatable cylinder is configured for massaging a back of the user and for realigning the vertebrae of the user, the actuator comprising:
a motor engaged to the rectangular frame proximate to the second endpoint of the rectangular frame,
a drive gear engaged to a shaft of the motor,
a rod engaged to and extending from the first endpoint of the rectangular frame,
a cog wheel rotationally engaged to the rod distal from the first endpoint,
an endless chain gearedly engaged to the drive gear and the cog wheel, and
a bar rotationally engaged to and extending between the endless chain and the plate, such that, as the endless chain rotates around the drive gear and the cog wheel, the rotatable cylinder is cycled the between the first edge and the second edge of the void;
a power module engaged to the rectangular frame and being operationally engaged to the motor, such that the power module is positioned for selectively powering the motor, the power module comprising a power cord;
a controller communicatively engaged to the power module and the motor, wherein the controller is configured for being selectively manipulated by the user for selectively powering the motor, the controller comprising an ON/OFF switch; and
a cover shaped complementarily to the pad, such that the cover is positionable over the pad, the void, and the rotatable cylinder, the cover being resiliently stretchable, the cover being padded.
